(19) United States
(12) Patent Application Publication
(10) Pub. No.: US 2025/0070323 A1
(43) Pub. Date: Feb. 27, 2025

(54) METAL-AIR BATTERY SYSTEM

(71) Applicant: MITSUBISHI HEAVY INDUSTRIES, LTD., Tokyo (JP)

(72) Inventors: Sho Araki, Tokyo (JP); Toshiyasu Kiyabu, Tokyo (JP); Yoshinori Noguchi, Tokyo (JP); Hidemasa Kakigami, Tokyo (JP); Kaoru Egawa, Tokyo (JP)

(73) Assignee: MITSUBISHI HEAVY INDUSTRIES, LTD., Tokyo (JP)

(21) Appl. No.: 18/714,037

(22) PCT Filed: Feb. 20, 2023
(86) PCT No.: PCT/JP2023/005940

§ 371 Date: May 28, 2024

(30) Foreign Application Priority Data
Apr. 11, 2022 (JP) 2022-065252

(51) Int. Cl. H01M 12/06; H01M 8/0438; H01M 8/04537; H01M 8/04746

(52) U.S. Cl. CPC H01M 12/06; H01M 8/04432; H01M 8/04552; H01M 8/04746

(57) ABSTRACT

A metal-air battery system includes: an inlet chamber into which an electrolyte solution flows; an outlet chamber from which the electrolyte solution flows out; a hollow outer electrode having an interior space via which the inlet chamber and the outlet chamber communicate with each other; and an inner electrode disposed to be inserted into the interior space concentrically with the outer electrode. One of the outer electrode and the inner electrode is a negative electrode containing metal, and the other is a porous positive electrode allowing oxygen to diffuse. A flow path through which the electrolyte solution flows from the inlet chamber toward the outlet chamber is formed between the outer electrode and the inner electrode, and the flow path is configured such that a flow-path cross-sectional area thereof decreases from a side of the inlet chamber toward a side of the outlet chamber.

### TECHNICAL FIELD

The present disclosure relates to a metal-air battery system.

This application claims the priority of Japanese Patent Application No. 2022-065252 filed on Apr. 11, 2022, the content of which is incorporated herein by reference.

### BACKGROUND

A metal-air battery system is known which uses metal as a negative-electrode active material and uses oxygen (air) as a positive-electrode active material. In such a metal-air battery system, the metal of the negative-electrode active material is deposited on a negative-electrode surface during charge. At this time, on the negative-electrode surface, there is a portion where a current density is locally high depending on a surface condition, and the metal is selectively deposited in this portion. When this metal grows dendritically (a dendrite is generated) as a charge/discharge cycle progresses, the dendrite penetrates a separator and reaches the positive electrode, causing an internal short circuit.

Although not a metal-air battery system. Patent Document 1 describes an invention in which at least one type of layer selected from a conductor layer, a semiconductor layer, or an insulating layer is disposed between a negative electrode and a separator in a secondary battery using lithium or zinc, or lithium alloy or zinc alloy as a negative-electrode active material. According to this invention, even if a dendrite grows and short-circuits with the conductor layer, a current density of the negative electrode during charge decreases and the dendrite cannot grow any further, making it possible to prevent the dendrite from penetrating the separator and reaching a positive electrode.

### CITATION LIST

### Patent Literature

Patent Document 1: JP2943127B

### SUMMARY

### Technical Problem

However, even if the invention of Patent Document 1 is applied to the metal-air battery system, the generation of the dendrite cannot be suppressed, making it impossible to completely prevent the dendrite from penetrating the separator and reaching the positive electrode.

In view of the above, an object of at least one embodiment of the present disclosure is to provide a metal-air battery system that can suppress the generation of a dendrite.

### Solution to Problem

In order to achieve the above object, a metal-air battery system according to the present disclosure, includes: an inlet chamber into which an electrolyte solution flows; an outlet chamber from which the electrolyte solution flows out; a hollow outer electrode having an interior space via which the inlet chamber and the outlet chamber communicate with each other; and an inner electrode disposed to be inserted into the interior space concentrically with the outer electrode. One of the outer electrode and the inner electrode is a negative electrode containing metal, and the other is a porous positive electrode allowing oxygen to diffuse. A flow path through which the electrolyte solution flows from the inlet chamber toward the outlet chamber is formed between the outer electrode and the inner electrode, and the flow path is configured such that a flow-path cross-sectional area thereof decreases from a side of the inlet chamber toward a side of the outlet chamber.

### Advantageous Effects

The concentration of active species ions in an electrolyte solution flowing through a flow path decreases downstream in a flow direction of the electrolyte solution, and such variation in concentration causes a non-uniform deposition form of metal on a negative electrode, resulting in an environment where a dendrite is likely to be generated. In contrast, according to the metal-air battery system of the present disclosure, since the flow velocity of the electrolyte solution flowing through the flow path increases downstream in the flow direction of the electrolyte solution by configuring such that the flow-path cross-sectional area of the flow path through which the electrolyte solution flows decreases from an inlet chamber side toward an outlet chamber side, a reaction on the downstream side is less likely to enter a diffusion-controlled state of active ionic species, making it possible to suppress the occurrence of a locally concentrated metal deposition region. As a result, it is possible to suppress the generation of the dendrite.

### BRIEF DESCRIPTION OF DRAWINGS

FIG. 1 is a schematic configuration diagram of a metal-air battery system according to Embodiment 1 of the present disclosure.

FIG. 2 is a partial schematic configuration diagram of the metal-air battery system according to Embodiment 2 of the present disclosure.

FIG. 3 is a schematic configuration diagram of an electrode cell of the metal-air battery system according to Embodiment 3 of the present disclosure.

FIG. 4 is a schematic configuration diagram of the electrode cell of the metal-air battery system according to Embodiment 4 of the present disclosure.

FIG. 5 is a partial cross-sectional schematic view for describing an operation of moving an inner electrode in the electrode cell of the metal-air battery system according to Embodiment 4 of the present disclosure.

FIG. 6 is a schematic view showing the configuration of an example of a flow control device disposed in the metal-air battery system according to Embodiment 4 of the present disclosure.

FIG. 7 is a cross-sectional view for describing patterns of a metal electrodeposition form on a surface of the inner electrode in the metal-air battery system according to Embodiment 4 of the present disclosure.

FIG. 8 is a schematic configuration diagram of the electrode cell of the metal-air battery system according to Embodiment 5 of the present disclosure.

FIG. 9 is a schematic configuration diagram of the electrode cell of the metal-air battery system according to Embodiment 6 of the present disclosure.

FIG. 10 is a schematic configuration diagram showing a modified example of the electrode cell of the metal-air battery system according to Embodiment 6 of the present disclosure.

### DETAILED DESCRIPTION

Hereinafter, a metal-air battery system according to embodiments of the present disclosure will be described with reference to the drawings. The embodiment to be described below indicates one aspect of the present disclosure, does not intend to limit the disclosure, and can optionally be modified within a range of a technical idea of the present disclosure.

### Embodiment 1

### <Configuration of Metal-Air Battery System According to Embodiment 1 of Present Disclosure>

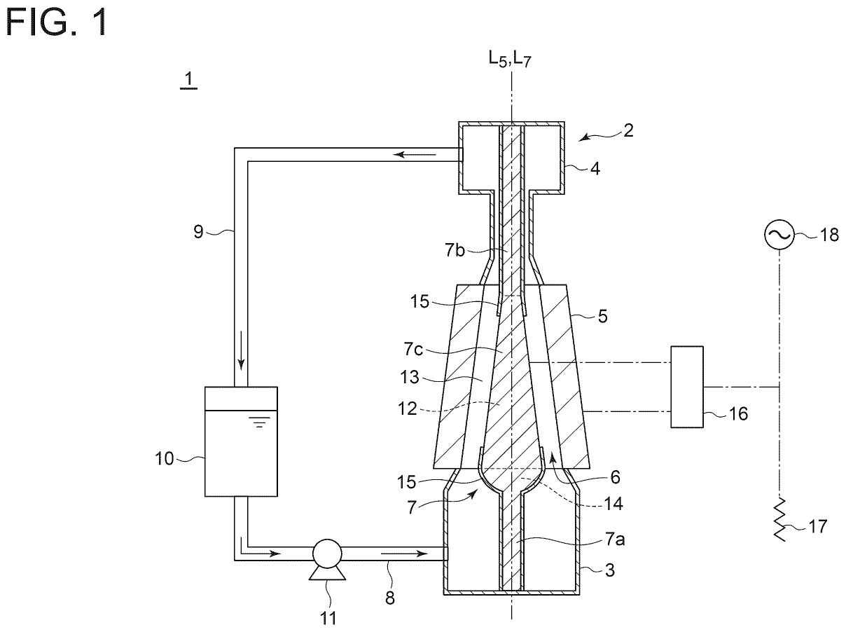

As shown in FIG. 1, a metal-air battery system 1 according to Embodiment 1 of the present disclosure includes an electrode cell 2. The electrode cell 2 includes an inlet chamber 3, an outlet chamber 4, a hollow outer electrode 5 having an interior space 6 via which the inlet chamber 3 and the outlet chamber 4 communicate with each other, and an inner electrode 7 fixed in a state of being inserted into the interior space 6 concentrically with the outer electrode 5. The inlet chamber 3 is connected to one end of an electrolyte inflow pipe 8 for an electrolyte solution described later to flow into the inlet chamber 3. The outlet chamber 4 is connected to one end of an electrolyte outflow pipe 9 for the electrolyte solution to flow out of the outlet chamber 4. Another end of each of the electrolyte inflow pipe 8 and the electrolyte outflow pipe 9 is connected to an electrolyte tank 10 for storing the electrolyte solution. The electrolyte inflow pipe 8 is provided with a pump 11.

As the electrolyte solution, it is possible to use either an aqueous electrolyte solution in which an electrolyte is dissolved in water or a non-aqueous electrolyte in which an electrolyte is dissolved in a non-aqueous solution such as an organic solvent. As the aqueous electrolyte solution, for example, an aqueous solution can be used which contains, as an electrolyte, a hydroxide such as potassium, sodium, lithium, barium, magnesium, etc., a chloride, a phosphate, a borate, a sulfate, etc. That is, any indicator salt for imparting electrical conductivity of the aqueous solution can be used as the electrolyte. As the non-aqueous electrolyte solution, it is possible to use, for example, a solution obtained by dissolving an indicator salt containing an alkali metal etc. in a liquid such as a cyclic or chain carbonate, a cyclic or chain ester, a cyclic or chain ether, a sulfone compound, an ionic liquid, etc.

In Embodiment 1, the outer electrode 5 is the positive electrode and the inner electrode 7 is the negative electrode. The outer electrode 5 is configured such that the cross-sectional area of the interior space 6, which is cut in a plane perpendicular to an axis L₅ of the outer electrode 5, decreases from an inlet chamber 3 side toward an outlet chamber 4 side. In Embodiment 1, as a specific example of the above, the description will be given assuming that the interior space 6 has a truncated conical configuration. The inner electrode 7 is configured to have a portion where the cross-sectional area cut in a plane perpendicular to an axis L₇ of the inner electrode 7 decreases from the inlet chamber 3 side toward the outlet chamber 4 side. In Embodiment 1, as a specific example of that portion, the description will be given assuming a configuration where the inner electrode 7 includes a truncated conical portion 12 having a truncated conical shape. This portion is not limited to the truncated conical shape, but may be a conical portion having a conical shape.

By inserting the inner electrode 7 into the interior space 6, a flow path 13 is formed between the outer electrode 5 and the inner electrode 7, which allows an electrolyte solution to flow from the inlet chamber 3 toward the outlet chamber 4. Since each of the outer electrode 5 and the inner electrode 7 has the above-described configuration, the flow path 13 is configured such that the cross-sectional area thereof decreases from the inlet chamber 3 side toward the outlet chamber 4 side.

The inner electrode 7 may have an inlet-side portion 14 upstream of the truncated conical portion 12 in a flow direction of the electrolyte solution. At least a part of the inlet-side portion 14 protrudes from the interior space 6 into the inlet chamber 3. The inlet-side portion 14 preferably has a rotationally symmetrical shape with respect to the axis L₇ of the inner electrode 7. The rotationally symmetric shape is a shape which is circumferentially symmetric about the axis L₇, such as the truncated conical shape or a hemispherical shape which is reverse in the flow direction of the electrolyte solution, and is a shape which does not disrupt the flow of the electrolyte solution along the circumferential direction of the inlet-side portion 14. According to such configuration, it is possible to suppress the disruption of the flow of the electrolyte solution, which has flowed into the inlet chamber 3, in the inlet-side portion 14 until the electrolyte solution flows into the flow path 13. If the inlet-side portion 14 is hemispherical, a connection portion between the inlet-side portion 14 and the truncated conical portion 12 has a smooth configuration, making it also possible to suppress the disruption of the flow of the electrolyte solution, which has flowed into the inlet chamber 3, in the connection portion until the electrolyte solution flows into the flow path 13.

On a surface of the inner electrode 7, an insulating layer 15 is disposed in each of an upstream region 7a which is a region upstream in the flow direction of the electrolyte solution and a downstream region 7b which is a region downstream in the flow direction of the electrolyte solution. The entirety of a current-carrying region 7c where the surface is exposed between the upstream region 7a and the downstream region 7b is located in the interior space 6, thereby facing the outer electrode 5.

The inner electrode 7 which is the negative electrode is an electrode containing the metal, and may be a an electrode produced with, for example, zinc or may be an electrode in which a surface of a body produced with other metal such as stainless steel or aluminum is plated with zinc. The metal contained in the inner electrode 7 is not limited to zinc. Iron, aluminum, lithium, sodium, potassium, copper, magnesium, etc., or an alloy thereof can be used depending on the type of electrolyte solution (for example, a difference in aqueous electrolyte solution/non-aqueous electrolyte solution).

The outer electrode 5 which is the positive electrode is a porous electrode allowing oxygen to diffuse, and can use, for example, an electrode having a three-layer structure including a porous outermost layer for allowing oxygen to diffuse, a porous intermediate layer formed of metal such as nickel, and an innermost layer in which an oxygen reduction catalyst is supported on a conductive material such as carbon. As the oxygen reduction catalyst, a catalyst mainly containing platinum as an active component (for example, platinum-supported carbon) can be used under an acidic liquid environment. Also, a catalyst containing, as an active component, 3d transition metal such as iron, manganese, nickel, or cobalt, or its oxide can be used under an alkaline liquid environment. In addition, a catalyst containing ruthenium, silver, gold, or iridium as an active component can also be used under both the acidic liquid environment and the alkaline liquid environment. Further, a catalyst containing, as an active component, an organometallic complex, a carbon fiber (for example, a carbon nanotube), a nitrogen carbide, etc. can also be used.

The outer electrode 5 and the inner electrode 7 are each electrically connected to an AC/DC converter 16. The AC/DC converter 16 can electrically be connected to each of a load 17 and an AC power source 18. The AC/DC converter 16 is not required if a DC power source is used in place of the AC power source 18 and the load 17 operates on a direct current.

### <Operation of Metal-Air Battery System According to Embodiment 1 of Present Disclosure>

Next, an operation of the metal-air battery system 1 according to Embodiment 1 of the present disclosure will be described. First, the operation in which current flows to the load 17 due to discharge of the metal-air battery system 1 will be described. By starting the pump 11, the electrolyte solution in the electrolyte tank 10 is supplied into the inlet chamber 3 via the electrolyte inflow pipe 8. The electrolyte solution flowing into the inlet chamber 3 flows through the flow path 13 and flows into the outlet chamber 4. The electrolyte solution in the outlet chamber 4 flows out of the outlet chamber 4, flows through the electrolyte outflow pipe 9, and flows into the electrolyte tank 10. The electrolyte solution thus circulates between the electrolyte tank 10 and the electrode cell 2.

While the electrolyte solution flows through the flow path 13, the following reactions occur at the outer electrode 5 and the inner electrode 7. At the inner electrode 7, in the current-carrying region 7c, the metal contained in the inner electrode 7, such as zinc, reacts with hydroxide ions in the electrolyte solution to produce zincate ions, and electrons are emitted to the inner electrode 7. The emitted electrons pass through the AC/DC converter 16 and flow into the outer electrode 5. At the outer electrode 5, oxygen contained in air outside the electrode cell 2 diffuses through the outermost layer and the intermediate layer, and hydroxide ions are produced by reactions between the air, water in the electrolyte solution, and the electrons having flowed into the outer electrode 5, due to the oxygen reduction catalyst in the innermost layer. The produced hydroxide ions are used in the above-described reaction at the inner electrode 7.

As the electrons flow from the inner electrode 7 to the outer electrode 5 by such operation, DC current flows from the outer electrode 5 to the inner electrode 7. The AC/DC converter 16 converts this DC current into AC current and supplies the AC current to the load 17.

Next, the charging operation of the metal-air battery system 1 will be described. In the state where the electrolyte solution circulates between the electrolyte tank 10 and the electrode cell 2, the AC current is supplied from the AC power source 18 to the AC/DC converter 16. The AC current from the AC power source 18 is converted into DC current by the AC/DC converter 16, and the DC current flows to the outer electrode 5. That is, electrons flow to the inner electrode 7. At the inner electrode 7, zinc ions in the electrolyte solution receive electrons, thereby depositing zinc on the inner electrode 7, and the metal-air battery system 1 is charged.

No problem occurs if zinc is uniformly deposited on the surface of the current-carrying region 7c in the inner electrode 7 during such charging, but in practice, a dendrite partially extending like a needle may be generated. If the dendrite is generated and grows, the dendrite may connect the inner electrode 7 and the outer electrode 5. Then, an internal short circuit occurs and the voltage of the battery becomes 0 V, making it impossible to charge the battery. In particular, the concentration of active species ions in the electrolyte solution flowing through the flow path 13 decreases downstream in the flow direction of the electrolyte solution, and such variation in concentration causes a non-uniform deposition form of metal on the inner electrode 7, resulting in an environment where a dendrite is likely to be generated.

In contrast, in the metal-air battery system 1 according to Embodiment 1, since the flow velocity of the electrolyte solution flowing through the flow path 13 increases downstream in the flow direction of the electrolyte solution by configuring such that the flow-path cross-sectional area of the flow path 13 through which the electrolyte solution flows decreases from the inlet chamber 3 side toward the outlet chamber 4 side, the reaction on the downstream side is less likely to enter a diffusion-controlled state of the active ionic species, making it possible to suppress the occurrence of a locally concentrated metal deposition region. As a result, it is possible to suppress the generation of the dendrite.

### Embodiment 2

Next, the metal-air battery system according to Embodiment 2 will be described. In the metal-air battery system according to Embodiment 2, the configuration of the outer electrode 5 is modified, relative to Embodiment 1. In Embodiment 2, the same constituent elements as those in Embodiment 1 are associated with the same reference signs and not described again in detail.

### <Configuration of Metal-Air Battery System According to Embodiment 2 of Present Disclosure>

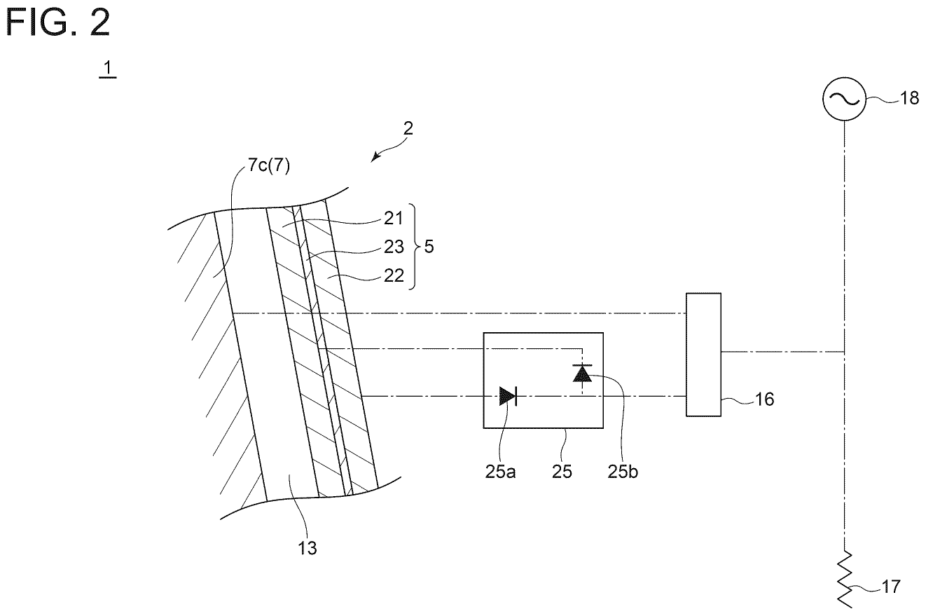

As shown in FIG. 2, the outer electrode 5 has a three-layer structure including a charging positive electrode 21 facing the inner electrode 7, a discharging positive electrode 22 located on an opposite side of the charging positive electrode 21 from the inner electrode 7, and a separator 23 located between the charging positive electrode 21 and the discharging positive electrode 22. A tubular electrode produced in mesh shape with a non-oxidizing porous metal material such as nickel or nickel alloy, or stainless steel can be used as the charging positive electrode 12a. The discharging positive electrode 22 can have the same configuration as in Embodiment 1. For example, an anion exchange membrane, a microporous membrane formed from polymer, solid oxide, or the like, etc. can be used as the separator 23.

The metal-air battery system 1 includes a switching device 25. The switching device 25 is configured to be switchable such that either the charging positive electrode 21 or the discharging positive electrode 22 energizes the AC/DC converter 16, that is, the inner electrode 7 is electrically connected to either the charging positive electrode 21 or the discharging positive electrode 22. Although the configuration of the switching device 25 is not particularly limited, for example, the switching device 25 may be composed of a first diode 7a for flowing a current in a direction from the discharging positive electrode 22 to the inner electrode 7, and a second diode 25b for flowing a current in a direction from the inner electrode 7 to the charging positive electrode 21. A switching device may be used which uses mechanical switches instead of the diodes. Other configurations are the same as in Embodiment 1.

### <Operation of Metal-Air Battery System According to Embodiment 2 of Present Disclosure>

Next, an operation of the metal-air battery system 1 according to Embodiment 2 of the present disclosure will be described. During discharge of the metal-air battery system 1, a current flows sequentially from the discharging positive electrode 22 of the outer electrode 5 to the first diode 25a, the AC/DC converter 16, and the inner electrode 7. During charge of the metal-air battery system 1, a current flows sequentially from the inner electrode 7 to the AC/DC converter 16, the second diode 25b, and the charging positive electrode 21. Other operations are the same as those in Embodiment 1.

Even with the configuration where the outer electrode 5 as the positive electrode has the charging positive electrode 21 and the discharging positive electrode 22 as in Embodiment 2, it is possible to obtain the same operation effect as in Embodiment 1 if the configuration of the flow path 13 is the same as in Embodiment 1.

In Embodiment 2, even if the dendrite is generated and an internal short circuit occurs during charge, discharge can be performed using the inner electrode 7 and the discharging positive electrode 22. Further, it is possible to reduce the risk of opposite reactions occurring at the positive electrode during charge and discharge, and improvements in efficiency and lifetime can be expected.

### Embodiment 3

Next, the metal-air battery system according to Embodiment 3 will be described. In the metal-air battery system according to Embodiment 3, the positive electrode and the negative electrode are interchanged, relative to Embodiment 1. In Embodiment 3, the same constituent elements as those in Embodiment 1 are associated with the same reference signs and not described again in detail.

### <Configuration of Metal-Air Battery System According to Embodiment 3 of Present Disclosure>

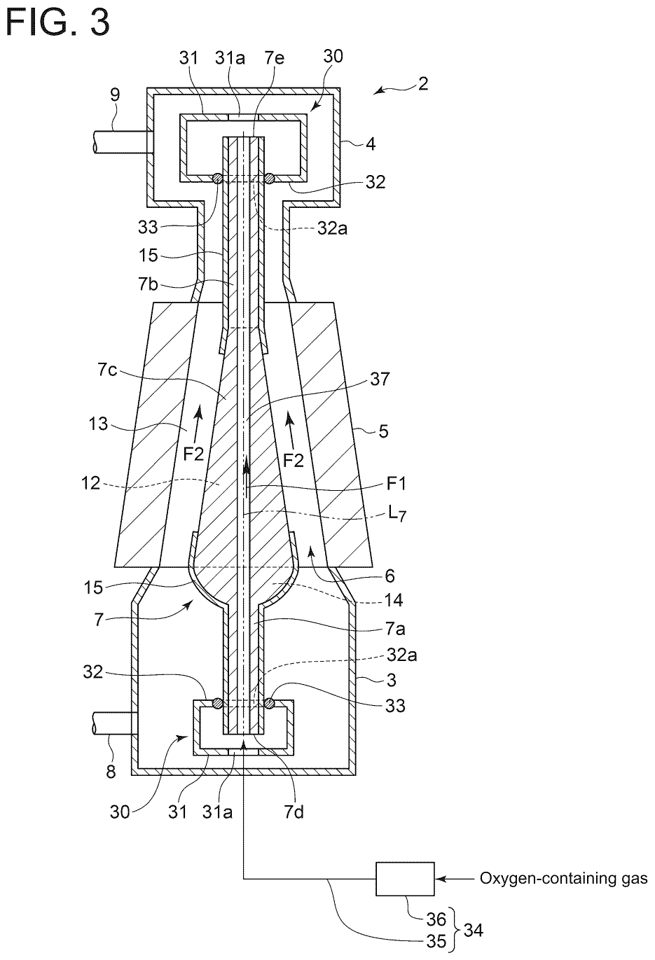

As shown in FIG. 3, in Embodiment 3, the outer electrode 5 is the negative electrode and the inner electrode 7 is the positive electrode. Thus, in Embodiment 3, the outer electrode 5 is an electrode produced with metal, and the inner electrode 7 is a porous electrode for allowing oxygen to diffuse. The inner electrode 7 is fixed in a state where the entire thereof is housed in the electrode cell 2. In the inner electrode 7, a hollow portion 37 is formed so as to penetrate the inner electrode 7 along the axis L₇. Both ends 7d, 7e of the inner electrode 7 along the axis L₇ are located in interiors of the inlet chamber 3 and the outlet chamber 4, respectively, causing the interior of the inlet chamber 3 and the interior of the outlet chamber 4 to communicate with each other not only via the flow path 13 but also via the hollow portion 37.

The respective interiors of the inlet chamber 3 and the outlet chamber 4 are provided with separation members 30 separating the electrolyte solution in the electrode cell 2 into a first flow F1 flowing through the hollow portion 37 and second flows F2 flowing through the flow path 13. The separation members 30 each have a tubular shape in which end faces 31, 32 are disposed at both ends in a direction of the axis L₇ of the inner electrode 7 when disposed the respective interiors of the inlet chamber 3 and the outlet chamber 4 and openings 31a, 32a are respectively formed in the end faces 31, 32. In a state where the inner electrode 7 is inserted into the one opening 32a and the both ends 7d, 7e are located inside the respective separation members 30, a seal member 33 such as an O-ring is disposed between an inner peripheral edge of the opening 32a and an outer peripheral surface of the inner electrode 7.

An oxygen-containing gas supply device 34 for supplying an oxygen-containing gas such as air is disposed inside the separation member 30 disposed in the inlet chamber 3. As the oxygen-containing gas supply device 34, it is possible to use, for example, a bubbling device that includes an oxygen-containing gas supply line 35 having one end located inside the separation member 30 and another end opening to the outside of the electrode cell 2 or connected to an oxygen-containing gas cylinder, etc., and a compressor 36 disposed on the oxygen-containing gas supply line 35. Other configurations are the same as in Embodiment 1.

### <Operation of Metal-Air Battery System According to Embodiment 3 of Present Disclosure>

Next, the operation of the metal-air battery system 1 according to Embodiment 3 of the present disclosure will be described, focusing on differences from the operation of the metal-air battery system 1 according to Embodiment 1. During discharge of the metal-air battery system 1, in the electrode cell 2, part of the electrolyte solution having flowed into the inlet chamber 3 enters into the separation member 30. The oxygen-containing gas pressurized by the compressor 36 is supplied via the oxygen-containing gas supply line 35 into the separation member 30 disposed in the inlet chamber 3, thereby bubbling the oxygen-containing gas into the electrolyte solution and obtaining an oxygen-dissolved electrolyte solution. The oxygen-dissolved electrolyte solution flows into the hollow portion 37 and flows through the hollow portion 37 as the first flow F1. The electrolyte solution having flowed through the hollow portion 37 flows out to the inside of the separation member 30 disposed in the outlet chamber 4, and flows out to the outside of the separation member 30 via the opening 31a.

On the other hand, the electrolyte solution which does not enter into the separation member 30 disposed in the inlet chamber 3 flows through the flow path 13 as the second flows F2 and flows into the outlet chamber 4. The electrolyte solution flowing as the first flow F1 and the electrolyte solution flowing as the second flows F2 merge in the outlet chamber 4 and flow out from the outlet chamber 4.

While the electrolyte solution thus flows in the electrode cell 2, the same reactions as the reactions described in Embodiment 1 occur in the outer electrode 5 as the negative electrode and the inner electrode 7 as the positive electrode. However, in Embodiment 3, oxygen contained in the electrolyte solution flowing through the hollow portion 37 diffuses in the inner electrode 7, and hydroxide ions are produced by reactions between oxygen, water in the electrolyte solution as the second flows F2, and electrons having flowed to the inner electrode 7, due to the oxygen reduction catalyst.

Further, during charge of the metal-air battery system 1, electrons flow to the outer electrode 5 and metal ions (such as zinc ions) in the electrolyte solution receive the electrons at the outer electrode 5, thereby depositing metal (such as zinc) on the outer electrode 5.

Even with the configuration where the outer electrode 5 is the negative electrode and the inner electrode 7 is the positive electrode as in Embodiment 3, it is possible to obtain the same operation effect as in Embodiment 1 if the configuration of the flow path 13 is the same as in Embodiment 1.

### <Modified Example of Metal-Air Battery System According to Embodiment 3 of Present Disclosure>

In Embodiment 3, the electrolyte solution bubbled with the oxygen-containing gas flows through the hollow portion 37 as the first flow F1, but the present disclosure is not limited to this form. Not the oxygen-dissolved electrolyte solution but the oxygen-containing gas may flow through the hollow portion 37 as the first flow F1.

### <Arrangement of Positive Electrode and Negative Electrode in Embodiments 1 to 3 of Present Disclosure>

In any of Embodiments 1 to 3, since a difference in electrode area between the outer electrode 5 and the inner electrode 7 can be obtained by concentrically arranging the both electrodes, it is possible to reduce a current density during operation of the outer electrode 5 compared to the inner electrode 7. Although the inner electrode 7 is the negative electrode in Embodiments 1 and 2, the polarization of the positive electrode is greater than that of the negative electrode and it is necessary to reduce a resistance more, and thus with the arrangement in which the inner electrode 7 is the negative electrode and the outer electrode 5 is the positive electrode, it is possible to improve energy efficiency during charge and discharge. At this time, the current density ratio at the negative electrode to the positive electrode differs depending on the ratio of diameters in both end portions of the truncated cone in the current-carrying region 7c of the inner electrode 7. The greater a diameter ratio Dᵢₙ/Dₒᵤₜ, the greater the area of the outer electrode 5 facing the current-carrying region 7c, reducing the resistance, where, for example, Dᵢₙ is a diameter in the end portion of the truncated cone on the inlet chamber 3 side and Dₒᵤₜ is a diameter in the end portion of the truncated cone on the outlet chamber 4 side.

In Embodiment 3, compared to Embodiment 1 where the inner electrode 7 is the negative electrode, the area of the negative electrode relatively increases and the amount of metal deposited on the negative electrode increases, making it possible to increase the storage capacity. At this time, the increase in storage capacity differs depending on the ratio of the diameters in the both end portions of the truncated cone in the current-carrying region 7c of the inner electrode 7. The greater the diameter ratio Dᵢₙ/Dₒᵤₜ, the greater the area of the outer electrode 5 facing the current-carrying region 7c, increasing the storage capacity, where, for example, Dᵢₙ is the diameter in the end portion of the truncated cone on the inlet chamber 3 side and Dₒᵤₜ is the diameter in the end portion of the truncated cone on the outlet chamber 4 side.

### Embodiment 4

Next, the metal-air battery system according to Embodiment 4 will be described. In the metal-air battery system according to Embodiment 4, the inner electrode 7 is movable along its axis L₇, relative to each of Embodiments 1 to 3. Hereinafter, Embodiment 4 will be described in which the inner electrode 7 is movable, relative to the configuration of Embodiment 1. However, Embodiment 4 may be configured such that the inner electrode 7 is movable, relative to the configuration of Embodiment 2 or 3. In Embodiment 4, the same constituent elements as those in Embodiment 1 are associated with the same reference signs and not described again in detail.

### <Configuration of Metal-Air Battery System According to Embodiment 4 of Present Disclosure>

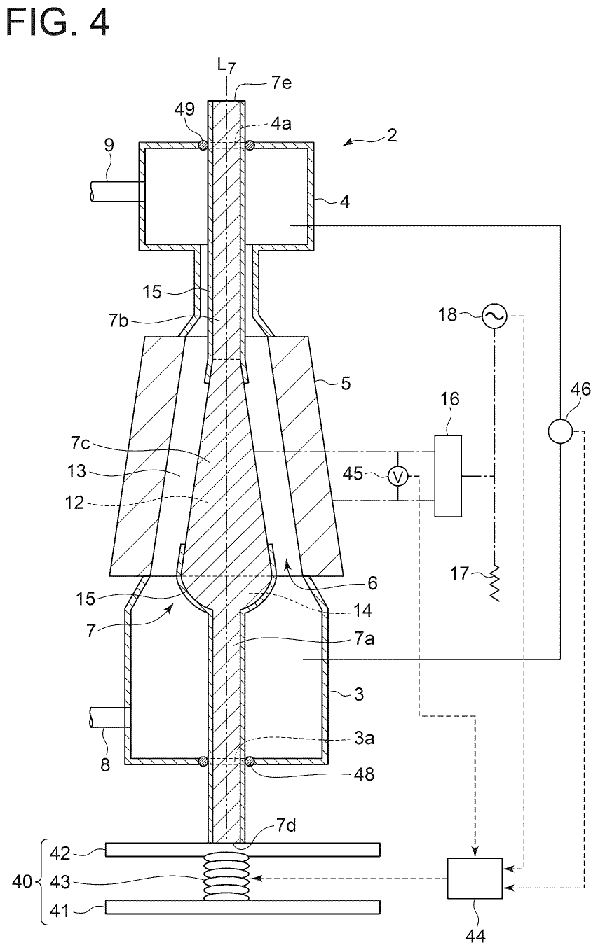

As shown in FIG. 4, in the metal-air battery system 1 according to Embodiment 4 of the present disclosure, the both ends 7d, 7e of the inner electrode 7 penetrate the inlet chamber 3 and the outlet chamber 4, respectively. The inlet chamber 3 and the outlet chamber 4 are respectively formed with openings 3a and 4a for the both ends 7d, 7e of the inner electrode 7 to penetrate through, and O-rings 48, 49 are disposed on respective inner peripheral surfaces of the openings 3a and 4a. The O-rings 48, 49 seal between the inner electrode 7 and the respective inner peripheral surfaces of the openings 3a and 4a.

A moving device 40 which is a moving device for moving the inner electrode 7 along its axis L₇ is disposed to face the end 7d of the inner electrode 7, which penetrates the inlet chamber 3. Although the configuration of the moving device 40 is not particularly limited, for example, the moving device 40 may include a fixed plate 41, a moving plate 42 to which the end 7d is fixed, and a piston portion 43 for moving the moving plate 42 with respect to the fixed plate 41 such that an interval between the fixed plate 41 and the moving plate 42 changes.

Further, the metal-air battery system 1 according to Embodiment 4 of the present disclosure may be provided with a voltmeter 45 for detecting a voltage between the outer electrode 5 and the inner electrode 7, a differential pressure gauge 46 for detecting a differential pressure between the inlet chamber 3 and the outlet chamber 4, and a control device 44 to which the voltmeter 45 and the differential pressure gauge 46 are electrically connected. The control device 44 is electrically connected to a drive device (not shown) for the piston portion 43 in the moving device 40 to drive the piston portion 43. Further, the control device 44 can detect the number of times the AC power source 18 is driven, by electrically connecting the AC power source 18 to the control device 44. The number of times the AC power source 18 is driven corresponds to the number of times the metal-air battery system 1 is charged (or the number of charge/discharge cycles), that is, an operating time of the metal-air battery system 1. Thus, the control device 44 has a function as a parameter detection device for detecting a parameter corresponding to the operating time of the metal-air battery system 1. The parameter detection device may be configured as a device separate from the control device 44. Other configurations are the same as in Embodiment 1.

The control device 44 includes, for example, a Central Processing Unit (CPU), a Random Access Memory (RAM), a Read Only Memory (ROM), a computer-readable storage medium, and the like. Then, a series of processes for realizing various functions is stored in the storage medium, etc. in the form of a program, as an example. The CPU reads the program out to the RAM, etc. and executes processing/calculation of information, thereby realizing the various functions. A configuration where the program is installed in the ROM or another storage medium in advance, a configuration where the program is provided in a state of being stored in the computer-readable storage medium, a configuration where the program is distributed via a wired or wireless communication means, etc. may be applied. The computer-readable storage medium is a magnetic disk, a magneto-optical disk, a CD-ROM, a DVD-ROM, a semiconductor memory, etc.

### <Operation of Metal-Air Battery System According to Embodiment 4 of Present Disclosure>

The operation in Embodiment 4 is the same as that in Embodiment 1 except that the moving device 40 moves the inner electrode 7 along its axis L₇. Therefore, the operation of moving the inner electrode 7 will be described below. When the piston portion 43 is driven to extend in the moving device 40, the moving plate 42 moves away from the fixed plate 41, that is, closer to the inlet chamber 3. Whereby, the inner electrode 7 whose end 7d is fixed to the moving plate 42 moves along its axis L₇ in the direction from the inlet chamber 3 toward the outlet chamber 4. Conversely, when the piston portion 43 is driven to contract in the moving device 40, the moving plate 42 moves closer to the fixed plate 41, that is, away from the inlet chamber 3. Whereby, the inner electrode 7 moves along its axis L₇ in the direction from the outlet chamber 4 toward the inlet chamber 3. When the inner electrode 7 thus moves, since the O-rings 48,49 seal between the inner electrode 7 and the respective inner peripheral surfaces of the openings 3a and 4a, it is possible to prevent the electrolyte solution from leaking from the openings 3a and 4a.

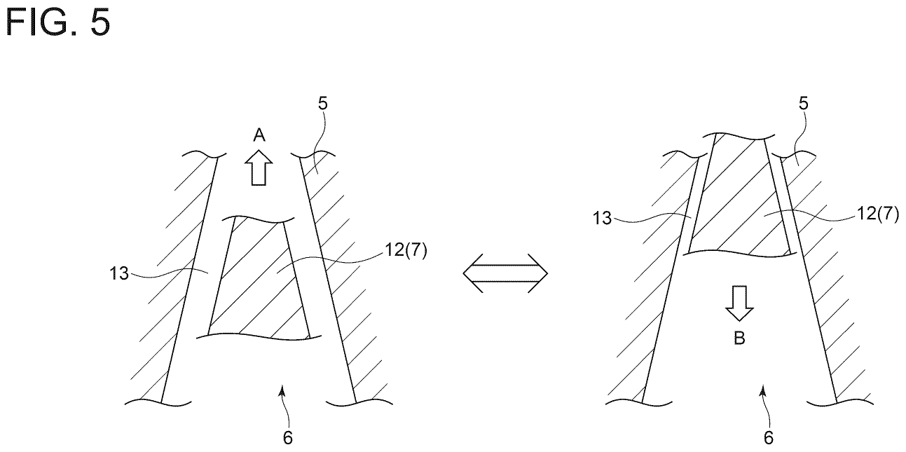

When the inner electrode 7 moves as described above, that is, in a direction of arrow A as shown in FIG. 5, an interval between the outer electrode 5 and the inner electrode 7, that is, a radial width of the flow path 13 decreases since both the interior space 6 of the outer electrode 5 and the truncated conical portion 12 of the inner electrode 7 are shaped to narrow in the direction of arrow A. If the inner electrode 7 continues to move in the direction of arrow A, eventually the inner electrode 7 (or the metal deposited on the surface of the inner electrode 7) contacts the outer electrode 5, and the inner electrode 7 cannot be moved any further in the direction of arrow A. This state is referred to as a case where the inner electrode 7 moves furthest to the outlet chamber 4 side. Conversely, when the inner electrode 7 moves in a direction of arrow B, the interval between the outer electrode 5 and the inner electrode 7, that is, the radial width of the flow path 13 increases. A state where the inner electrode 7 cannot be moved any further in the direction of arrow B is referred to as a case where the inner electrode 7 moves furthest to the inlet chamber 3 side. The inner electrode 7 can be located between both of these states, and the radial width of the flow path 13 can be adjusted within a range where widths in both of these states are a minimum value and a maximum value, respectively.

It is preferable to set ranges of the upstream region 7a and the downstream region 7b such that the current-carrying region 7c is located in the interior space, and to provide the insulating layers 15 in the upstream region 7a and the downstream region 7b, in both of the case where the inner electrode 7 moves furthest to the outlet chamber 4 side and the case where the inner electrode 7 moves furthest to the inlet chamber 3 side. With such configuration, even if a distance between the outer electrode 5 and the inner electrode 7 is changed, the current-carrying region 7c faces the outer electrode 5, making it possible to maintain an effective electrode surface area constant.

When the radial width of the flow path 13 is changed, the flow rate of the electrolyte solution flowing through the flow path 13 needs to be controlled. The metal-air battery system 1 may be provided with a flow control device for controlling the flow rate of the electrolyte solution according to the change in distance between the outer electrode 5 and the inner electrode 7. Although the configuration of such flow control device is not particularly limited, for example, the control device 44 is configured to detect a movement amount of the inner electrode 7 and calculate the distance between the outer electrode 5 and the inner electrode 7 from this movement amount. The control device 44 may adjust a discharge amount of the pump 11 based on this distance. In this case, the control device 44 constitutes the flow control device.

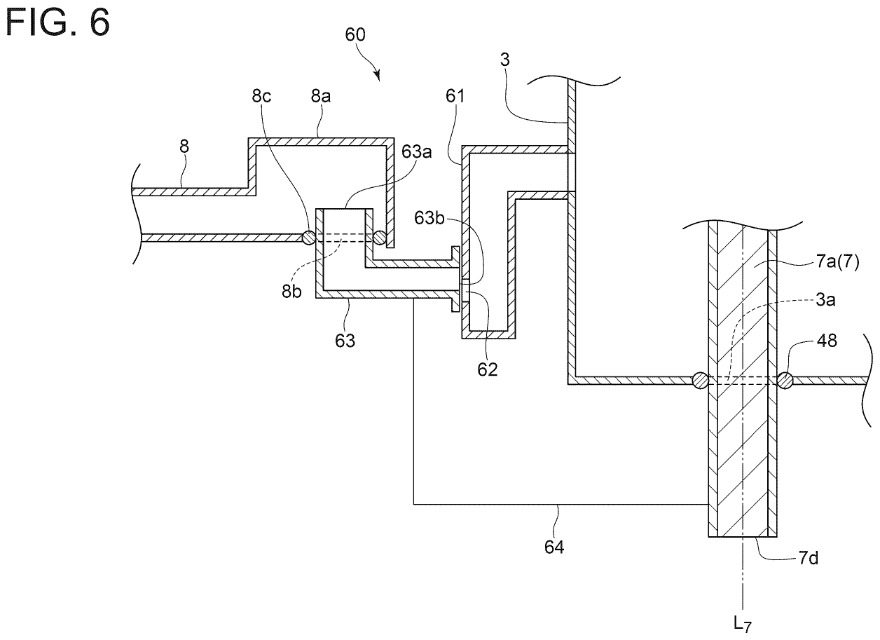

Another example of the flow control device will be described next. As shown in FIG. 6, a flow control device 60 is disposed between a downstream end portion of the electrolyte inflow pipe 8 and the inlet chamber 3. The flow control device 60 includes a first pipe 61 communicating with the inlet chamber, and a second pipe 63 communicating with the first pipe 61 via a hole 62 formed in the first pipe 61. In the downstream end portion of the electrolyte inflow pipe 8, a chamber portion 8a is formed which extends in a direction along the axis L₇ of the inner electrode 7, and an upstream opening end portion 63a of the second pipe 63 is being inserted into the chamber portion 8a via a hole 8b formed in the chamber portion 8a. An O-ring 8c is disposed on an inner peripheral surface of the hole 8b to seal between the inner peripheral surface of the hole 8b and the second pipe 63. A downstream opening end portion 63b of the second pipe 63 is located so as to face the hole 62. The second pipe 63 is disposed to be movable along the axis L₇, and is configured such that the opening area of the hole 62 with respect to the downstream opening end portion 63b of the second pipe 63 changes by moving the second pipe 63. If the second pipe 63 and the inner electrode 7 are connected by a connecting member 64, the second pipe 63 also moves along the axis L₇ as the inner electrode 7 moves along the axis L₇.

When the inner electrode 7 is moved up and down in FIG. 6 in order to adjust the radial width of the flow path 13 (see FIG. 5), the second pipe 63 is also moved up and down, increasing and decreasing the opening area of the hole 62 with respect to the downstream opening end portion 63b. By using such flow control device 60, it is possible to control, with the simple configuration, the flow rate of the electrolyte solution according to the change in distance between the outer electrode 5 and the inner electrode 7.

Although the position of the inner electrode 7 may manually be adjusted by manually driving the moving device 40 based on the various operating conditions (the voltage between the outer electrode 5 and the inner electrode 7, the differential pressure between the inlet chamber 3 and the outlet chamber 4, the number of times the metal-air battery system 1 is charged, etc.) of the metal-air battery system 1, the position of the inner electrode 7 can also be adjusted automatically according to the operating conditions of the metal-air battery system 1. In the former case, the control device 44 is not required, and a metal electrodeposition form at the negative electrode is estimated based on respective detected values of the voltmeter 45, the differential pressure gauge 46, and the parameter detection device, and the position of the inner electrode 7 is manually adjusted. Hereinafter, the operation in the latter case will be described. In the latter case, although the control device 44 estimates the metal electrodeposition form at the negative electrode based on the respective detected values of the voltmeter 45, the differential pressure gauge 46, and the parameter detection device, the estimation principle is the same for the both cases.

While the metal-air battery system 1 operates (is charged/discharged) and during standby between charge and discharge, the detected values respectively detected by the voltmeter 45, the differential pressure gauge 46, and the parameter detection device are transmitted to the control device 44. Based on these detected values, the control device 44 estimates the electrodeposition form of the metal deposited on the surface of the inner electrode 7. Although the estimation method is not particularly limited, an example of a method for estimating the metal electrodeposition form will be described below.

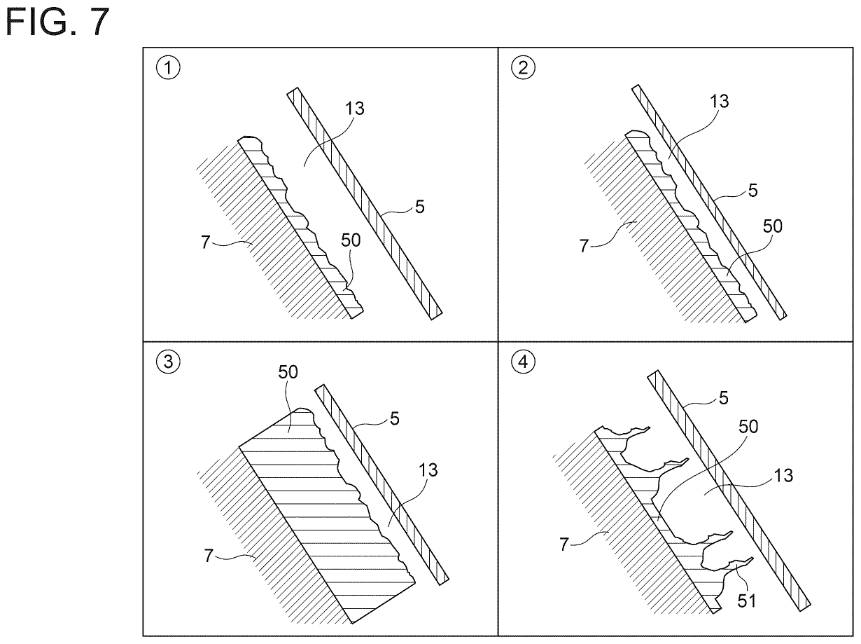

The control device 44 has thresholds set in advance for the detected values respectively detected by the voltmeter 45, the differential pressure gauge 46, and the parameter detection device, and determines whether the detected values respectively detected by the voltmeter 45, the differential pressure gauge 46, and the parameter detection device are larger or smaller than the thresholds. The control device 44 estimates the metal electrodeposition form based on the combination of whether each of these three detected values is larger or smaller than a corresponding one of the thresholds. Tables 1 to 3 below summarize a relationship between the electrodeposition form and the combination of the magnitude of these detected values with respect to the thresholds of these detected values, and actions to be taken, for each of during charge, during discharge, and during standby of the metal-air battery system 1. In the tables below, a case where each detected value is larger than each threshold is described as “large”, and a case where each detected value is smaller than each threshold is described as “small”. As to the electrodeposition form, four patterns (1) to (4) are described. As shown in FIG. 7, an electrodeposition form (1) is a form in which metal 50 is uniformly deposited on the surface of the inner electrode 7, the amount of the deposition is small, and the distance between the outer electrode 5 and the inner electrode 7 is large, sufficiently ensuring the radial width of the flow path 13. An electrodeposition form (2) is a form in which the metal 50 is uniformly deposited on the surface of the inner electrode 7, and the amount of the deposition is small, but the distance between the outer electrode 5 and the inner electrode 7 is small, reducing the radial width of the flow path 13. An electrodeposition form (3) is a form in which the metal 50 is uniformly deposited on the surface of the inner electrode 7, and the distance between the outer electrode 5 and the inner electrode 7 is large, but the deposition amount of the metal 50 is large, reducing the radial width of the flow path 13. An electrodeposition form (4) is a form in which the distance between the outer electrode 5 and the inner electrode 7 is large and the deposition amount of the metal 50 is small, but the metal is non-uniformly deposited on the surface of the inner electrode 7, causing a dendrite 51 and partially reducing the radial width of the flow path 13.

TABLE 1
during charge

| Detection item | | | Estimated | |
|---|---|---|---|---|
| | Differ- | | result of | |
| | ential | | electrodeposition | |
| Voltage | pressure | Parameter | form | Action to be taken |
| High | High | High | (4) | Minimize distance |
| | | | | between |
| | | | | electrodes/replace |
| | | | | electrode |
| | | Low | (4) | Extend distance |
| | | | | between |
| | | | | electrodes and |
| | | | | continue charge |
| | Low | High | (1) | Reduce distance |
| | | | | between electrodes |
| | | Low | (1) | Reduce distance |
| | | | | between electrodes |
| Low | High | High | (3) | Stop charge |
| | | Low | (2) | Continue charge while |
| | | | | maintaining distance |
| | | | | between electrodes |
| | Low | High | (1) | Reduce distance |
| | | | | between electrodes |
| | | Low | (1) | Reduce distance |
| | | | | between electrodes |

TABLE 2
during discharge

| Detection item | | | Estimated | |
|---|---|---|---|---|
| | Differ- | | result of | |
| | ential | | electrodeposition | |
| Voltage | pressure | Parameter | form | Action to be taken |
| High | High | High | (4) | Minimize distance |
| | | | | between electrodes |
| | | Low | (4) | Extend distance |
| | | | | between |
| | | | | electrodes and |
| | | | | continue discharge |
| | Low | High | (1) | Reduce distance |
| | | | | between electrodes |
| | | Low | (1) | Reduce distance |
| | | | | between electrodes |
| Low | High | High | (2) | Extend distance |
| | | | | between |
| | | | | electrodes and |
| | | | | continue discharge |
| | | Low | (3) | Extend distance |
| | | | | between |
| | | | | electrodes and |
| | | | | continue discharge |
| | Low | High | (1) | Reduce distance |
| | | | | between electrodes |
| | | Low | (1) | Reduce distance |
| | | | | between electrodes |

TABLE 3
during standby

| Detection item | | | Estimated | |
|---|---|---|---|---|
| | Differ- | | result of | |
| | ential | | electrodeposition | |
| Voltage | pressure | Parameter | form | Action to be taken |
| High | High | High | (4) | Minimize distance |
| | | | | between |
| | | | | electrodes/replace |
| | | | | electrode |
| | | Low | (4) | Extend distance |
| | | | | between electrodes |
| | Low | High | (1) | Reduce distance |
| | | | | between electrodes |
| | | Low | (1) | Reduce distance |
| | | | | between electrodes |
| Low | High | High | (2) or (3) | Start charge or |
| | | | | discharge while |
| | | | | maintaining distance |
| | | | | between electrodes |
| | | Low | (2) or (3) | Start charge or |
| | | | | discharge while |
| | | | | maintaining distance |
| | | | | between electrodes |
| | Low | High | (1) | Reduce distance |
| | | | | between electrodes |
| | | Low | (1) | Reduce distance |
| | | | | between electrodes |

In the “actions to be taken” in Tables 1 to 3, the distance between the electrodes is reduced or extended by moving the inner electrode 7. Further, minimizing the distance between the electrodes means that when the inner electrode 7 is moved toward the outlet chamber 4 side, the inner electrode 7 is moved until the inner electrode 7 cannot be moved any further. If there is no internal short circuit, the dendrite 51 is not in contact with the outer electrode 5, making it possible to move the inner electrode 7 at least until the dendrite 51 contacts the outer electrode 5. When the dendrite 51 contacts the outer electrode 5, the dendrite 51 may be broken and can be dislodged. In this case, the movement amount of the inner electrode 7 is relatively large, but in a case where the dendrite is hard and is not broken even when the dendrite contacts the outer electrode 5, the movement amount of the inner electrode 7 is relatively small. In the latter case, electrode replacement is preferred because an internal short circuit is likely to occur in a short period of time. The dendrite having been dislodged can be discharged from the electrode cell 2 along with the flow of the electrolyte solution. For example, if a filter, etc. is disposed at a connection portion with the electrolyte inflow pipe 8 in the electrolyte tank 10, the dendrite can be kept in the electrolyte tank 10, making it possible to prevent the dendrite from flowing back into the electrode cell 2.

Although not listed in Tables 1 to 3, if the detected value by the voltmeter 45 becomes zero, it means that an internal short circuit has occurred, regardless of the respective detected values of the differential pressure gauge 46 and the parameter detection device. In this case, the inner electrode 7 is moved to minimize the distance between the electrodes. Electrode replacement is preferred when the movement amount of the inner electrode 7 is relatively small.

The electrodeposition form of the metal 50 deposited on the surface of the inner electrode 7 can thus be estimated, and whereby the generation of the dendrite 51 can be estimated at an early stage, making it possible to quickly respond to a risk of the occurrence of the internal short circuit.

### Embodiment 5

Next, the metal-air battery system according to Embodiment 5 will be described. In the metal-air battery system according to Embodiment 5, the inner electrode 7 is rotatable with its axis L₇ as a rotation center, relative to Embodiment 4. In Embodiment 5, the same constituent elements as those in Embodiment 4 are associated with the same reference signs and not described again in detail.

### <Configuration of Metal-Air Battery System According to Embodiment 5 of Present Disclosure>

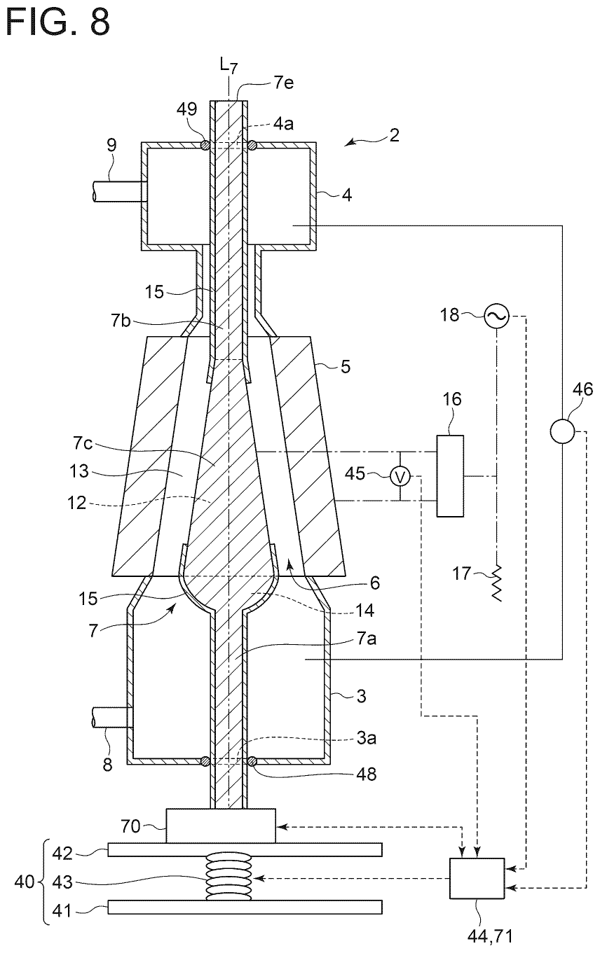

As shown in FIG. 8, the metal-air battery system 1 according to Embodiment 5 of the present disclosure is provided with a rotating device 70 for rotating the inner electrode 7 with its axis L₇ as the rotation center. The rotating device 70 is placed on the moving plate 42 of the moving device 40, allowing the inner electrode 7 to be moved along the axis L₇ by the moving device 40 and to rotate with the axis L₇ as the rotation center. The control device 44 electrically connected to the rotating device 70 may be provided, and the control device 44 may drive the rotating device 70. Other configurations are the same as in Embodiment 4. Rotation of the inner electrode 70 on its axis is not limited to continuous rotation on its axis in one direction, but also includes repeating an operation of rotating by a certain rotation angle in the one direction and then rotating by a certain rotation angle in an opposite direction.

### <Operation of Metal-Air Battery System According to Embodiment 5 of Present Disclosure>

In Embodiment 5, the operations of charging and discharging the metal-air battery system 1 are the same as in Embodiment 1, and the operation of moving the inner electrode 7 along the axis L₇ is the same as in Embodiment 4. Hereinafter, the operations that are different from those in Embodiments 1 and 4 will mainly be described.

When the internal short circuit occurs or when the generation of the dendrite is estimated, the rotating device 70 rotates the inner electrode 7 on its axis while the moving device 40 moves the inner electrode 7 toward the outlet chamber 4 side or after the inner electrode 7 moves furthest to the outlet chamber 4 side. When the inner electrode 7 rotates on its axis in the state where the dendrite contacts the outer electrode 5, the dendrite is broken and can be dislodged. Further, in Embodiment 5, in Tables 1 to 3, when the action to be taken is to “minimize the distance between the electrodes”, the dendrite can easily be dislodged by further rotating the inner electrode 7 on its axis.

When the inner electrode 7 is the negative electrode, the metal is deposited on the surface of the inner electrode 7, increasing the weight of the inner electrode 7 as the electrodeposition amount increases. Then, a load on the rotating device 70 for rotating the inner electrode 7 on its axis increases. Therefore, if a load detection device 71 for detecting the load on the rotating device 70 is provided, the control device 44 can use a detected value by the load detection device 71 to estimate the metal electrodeposition amount on the surface of the inner electrode 7. Although the configuration of the load detection device 71 is not particularly limited, for example, since the control device 44 can detect the load by measuring a current value of the rotating device 70, the control device 44 can be configured as the load detection device 71. The load detection device 71 may be provided as a device separate from the control device 44.

Although only the metal electrodeposition amount on the surface of the inner electrode 7 can be estimated from the load on the rotating device 70 alone, it is possible to more accurately estimate the electrodeposition form of the metal deposited on the surface of the inner electrode 7, by combining the load on the rotating device 70 with the voltage, the differential pressure, and the parameter detected in Embodiment 4. Whereby, the generation of the dendrite 51 can be estimated at an early stage, making it possible to quickly respond to the risk of the occurrence of the internal short circuit.

### Embodiment 6

Next, the metal-air battery system according to Embodiment 6 will be described. In the metal-air battery system according to Embodiment 6, an electrode to be rotated on its axis is changed to the outer electrode 5, relative to Embodiment 5. In Embodiment 6, the same constituent elements as those in Embodiment 5 are associated with the same reference signs and not described again in detail.

### <Configuration of Metal-Air Battery System According to Embodiment 6 of Present Disclosure>

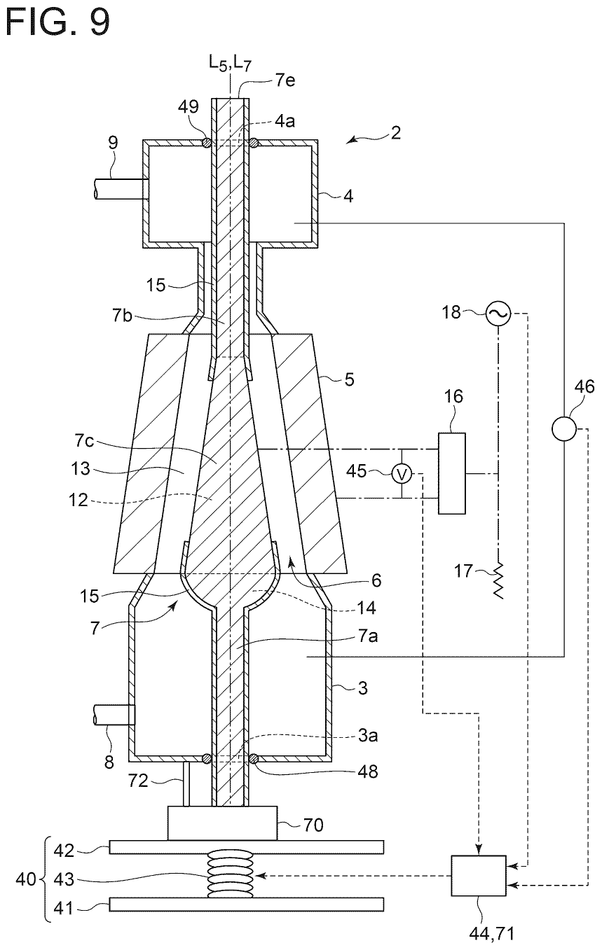

As shown in FIG. 9, in the metal-air battery system 1 according to Embodiment 5 of the present disclosure, the rotating device 70 includes a rotating body 72 connected to the electrode cell 2 (for example, the bottom of the inlet chamber 3), and the rotating body 72 is configured to rotate about the axes L₅ and L₇ of the outer electrode 5 and the inner electrode 7 as rotation centers. Other configurations are the same as in Embodiment 6.

### <Operation of Metal-Air Battery System According to Embodiment 6 of Present Disclosure>

The operation in Embodiment 6 differs from Embodiment 5 in that the outer electrode 5 is rotated by the rotating device 70. In Embodiment 6, since the inner electrode 7 does not rotate on its axis, the outer electrode 5 rotates with respect to the inner electrode 7. In this case as well, when the outer electrode 5 rotates on its axis in the state where the dendrite contacts the outer electrode 5, the dendrite is broken and can be dislodged. Further, in Embodiment 6 as well, in Tables 1 to 3, when the action to be taken is to “minimize the distance between the electrodes”, the dendrite can easily be dislodged by further rotating the outer electrode 5 on its axis. The control of the moving device 40 and the rotating device 70 by the control device 44 is the same as in Embodiment 5, except that the outer electrode 5 is rotated instead of the inner electrode 7.

### <Modified Example of Metal-Air Battery System According to Embodiment 7 of Present Disclosure>

In Embodiment 6, the outer electrode 5 is the positive electrode and the inner electrode 7 is the negative electrode, but like the electrode cell of the configuration shown in FIG. 3 of Embodiment 3, the outer electrode 5 may be the negative electrode and the inner electrode 7 may be the positive electrode. In this case, the metal is deposited on the outer electrode 5, increasing the weight of the outer electrode 5 as the electrodeposition amount increases. Then, the load on the rotating device 70 for rotating the inner electrode 7 on its axis increases. As in Embodiment 5, it is possible to estimate the metal electrodeposition amount on the surface of the outer electrode 5 based on the detected value of the load on the rotating device 70, which is detected by the load detection device 71, or it is possible to accurately estimate the electrodeposition form of the metal deposited on the surface of the outer electrode 5, by combining the detected value of the load with the voltage, the differential pressure, and the parameter. Whereby, the generation of the dendrite 51 can be estimated at an early stage, making it possible to quickly respond to the risk of the occurrence of the internal short circuit.

In Embodiment 6, w % ben the outer electrode 5 rotates on its axis, the inlet chamber 3 and the outlet chamber 4 also rotate on their axes together with the outer electrode 5. Since one end of the electrolyte inflow pipe 8 and one end of the electrolyte outflow pipe 9 are respectively connected to the inlet chamber 3 and the outlet chamber 4, and another end of the electrolyte inflow pipe 8 and another end of the electrolyte outflow pipe 9 are connected to the electrolyte tank 10, in practice, the outer electrode 5 may not be able to rotate on its axis due to interference from these.

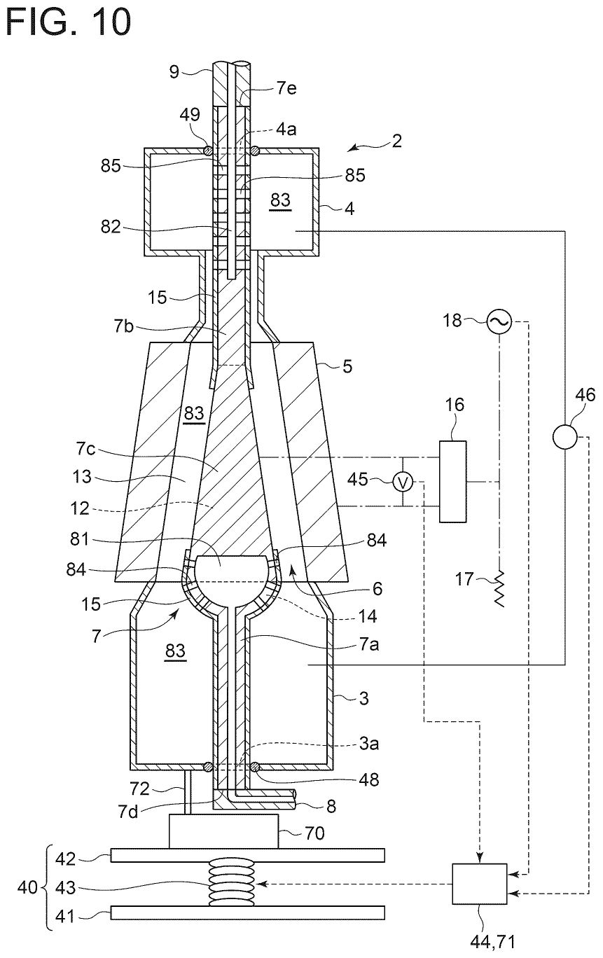

In contrast, if the electrode cell 2 as shown in FIG. 10 is adopted, the outer electrode 5 can rotate on its axis without being affected by the electrolyte inflow pipe 8, the electrolyte outflow pipe 9, the electrolyte tank 10, and the like. The inner electrode 7 is formed with a first hollow portion 81 formed in a part of the interior of the inner electrode 7, and a second hollow portion 82 formed in a part of the interior of the inner electrode 7, which is downstream of the first hollow portion 81 in the flow direction of the electrolyte solution. In the interior of the inner electrode 7, the first hollow portion 81 and the second hollow portion 82 do not communicate with each other. The both ends 7d, 7e of the inner electrode 7 are disposed to penetrate from the inlet chamber 3 and the outlet chamber 4 to exteriors thereof, respectively. The first hollow portion 81 is configured to open at the end 7d of the inner electrode 7, thereby communicating with the exterior of the inlet chamber 3. The second hollow portion 82 is also configured to open at the end 7e of the inner electrode 7, thereby communicating with the exterior of the outlet chamber 4. The inner electrode 7 is formed with through holes 84, 85 via which the first hollow portion 81 and the second hollow portion 82 respectively communicate with a closed space 83 composed of the interior of the inlet chamber 3, the interior of the outlet chamber 4, and the flow path 13.

In the electrode cell 2 having such configuration, the electrolyte solution flowing through the electrolyte inflow pipe 8 flows into the first hollow portion 81 and flows out from the first hollow portion 81 to the closed space 83 via the through hole 84. The electrolyte solution in the closed space 83, in particular in the outlet chamber 4 flows into the second hollow portion 82 via the through hole 85 and flows into the electrolyte outflow pipe 9 in the exterior of the outlet chamber 4.

According to such configuration, since there is no need to provide the inlet chamber 3 and the outlet chamber 4 with a pipe for supplying the electrolyte solution to the inlet chamber 3 and a pipe for flowing the electrolyte solution out of the outlet chamber 4, respectively, it is easier to configure the outer electrode 5 to be rotatable on its axis.

The contents described in the above embodiments would be understood as follows, for instance.

[1] A metal-air battery system according to one aspect, includes: an inlet chamber (3) into which an electrolyte solution flows; an outlet chamber (4) from which the electrolyte solution flows out; a hollow outer electrode (5) having an interior space (6) via which the inlet chamber (3) and the outlet chamber (4) communicate with each other; and an inner electrode (7) disposed to be inserted into the interior space (6) concentrically with the outer electrode (5). One of the outer electrode (5) and the inner electrode (7) is a negative electrode containing metal, and the other is a porous positive electrode allowing oxygen to diffuse. A flow path (3) through which the electrolyte solution flows from the inlet chamber (3) toward the outlet chamber (4) is formed between the outer electrode (5) and the inner electrode (7), and the flow path (13) is configured such that a flow-path cross-sectional area thereof decreases from a side of the inlet chamber (3) toward a side of the outlet chamber (4).

The concentration of active species ions in the electrolyte solution flowing through the flow path decreases downstream in the flow direction of the electrolyte solution, and such variation in concentration causes a non-uniform deposition form of metal on the negative electrode, resulting in an environment w % here a dendrite is likely to be generated. In contrast, according to the metal-air battery system of the present disclosure, since the flow velocity of the electrolyte solution flowing through the flow path increases downstream in the flow direction of the electrolyte solution by configuring such that the flow-path cross-sectional area of the flow path through which the electrolyte solution flows decreases from the inlet chamber side toward the outlet chamber side, the reaction on the downstream side is less likely to enter a diffusion-controlled state of active ionic species, making it possible to suppress the occurrence of a locally concentrated metal deposition region. As a result, it is possible to suppress the generation of the dendrite.

[2] A metal-air battery system according to another aspect is the metal-air battery system of [1], wherein the interior space (6) has a truncated conical shape, and the inner electrode (7) has a conical portion or a truncated conical portion (12) corresponding to the truncated conical shape of the outer electrode (5).

According to such configuration, the flow path through which the electrolyte solution flows can be configured such that the flow-path cross-sectional area of the flow path decreases from the inlet chamber side toward the outlet chamber side.

[3] A metal-air battery system according to yet another aspect is the metal-air battery system of [2], wherein the inner electrode (5) has an inlet-side portion (14) upstream of the conical portion or the truncated conical portion (12) in a flow direction of the electrolyte solution, and wherein the inlet-side portion (14) has a rotationally symmetric shape with respect to an axis (L₇) of the inner electrode (7).

According to such configuration, it is possible to suppress the disruption of the flow of the electrolyte solution, which has flowed into the inlet chamber, in the inlet-side portion until the electrolyte solution flows into the flow path.

[4] A metal-air battery system according to yet another aspect is the metal-air battery system of [3], wherein the inlet-side portion (14) has a hemispherical shape.

According to such configuration, a connection portion between the inlet-side portion and the conical portion or the truncated conical portion has a smooth configuration, making it possible to suppress the disruption of the flow of the electrolyte solution, which has flowed into the inlet chamber, in the connection portion until the electrolyte solution flows into the flow path.

[5] A metal-air battery system according to yet another aspect is the metal-air battery system of any of [2] to [4], including: a moving device (40) for moving the inner electrode (7) along an axis (L₇) of the inner electrode (7) with respect to the outer electrode (5).

According to such configuration, it is possible to easily control the distance between the positive electrode and the negative electrode.

[6] A metal-air battery system according to yet another aspect is the metal-air battery system of [5], wherein, on a surface of the inner electrode (7), an insulating layer (15) is disposed in each of an upstream region (7a) which is a region upstream in a flow direction of the electrolyte solution and a downstream region (7b) which is a region downstream in the flow direction of the electrolyte solution, and wherein a current-carrying region (7c) where the surface is exposed between the upstream region (7a) and the downstream region (7b) is located in the interior space (6) in both of a case where the inner electrode (7) moves furthest to the side of the outlet chamber (4) and a case where the inner electrode (7) moves furthest to the side of the inlet chamber (3).

According to such configuration, even if the distance between the positive electrode and the negative electrode is changed, the current-carrying region faces the outer electrode, making it possible to maintain an effective electrode surface area constant.

[7] A metal-air battery system according to yet another aspect is the metal-air battery system of either [5] or [6], including: a flow control device (60) for controlling a flow rate of the electrolyte solution flowing into the inlet chamber (3). The flow control device (60) is configured to control the flow rate of the electrolyte solution according to the movement of the inner electrode (7).

According to such configuration, it is possible to appropriately control the flow rate of the electrolyte solution flowing through the flow path, according to the change in distance between the negative electrode and the positive electrode.

[8] A metal-air battery system according to yet another aspect is the metal-air battery system of [7], wherein the flow control device (60) includes: a first pipe (61) communicating with the inlet chamber (3); and a second pipe (63) communicating with the first pipe (61) via a hole (62) formed in the first pipe (61), and wherein the second pipe (63) is configured to move together with the inner electrode (7) and is configured such that an opening area of the hole (62) with respect to the second pipe (63) changes with the movement of the second pipe (63).

According to such configuration, it is possible to control, with the simple configuration, the flow rate of the electrolyte solution, according to the change in distance between the negative electrode and the positive electrode.

[9] A metal-air battery system according to yet another aspect is the metal-air battery system of any of [5] to [8], including: a rotating device (70) for rotating either one of the inner electrode (7) or the outer electrode (5) with the axis (L₇ or L₅) of the inner electrode (7) or the outer electrode (5) as a rotation center.

According to such configuration, when a dendrite is generated, the dendrite can mechanically be dislodged by moving the inner electrode to bring about a state where a tip of the dendrite is in contact with the facing electrode and rotating the inner electrode or the outer electrode on its axis in that state.

[10] A metal-air battery system according to yet another aspect is the metal-air battery system of [9], wherein either the inner electrode (7) or the outer electrode (5) disposed to be rotatable on its axis is a negative electrode, and wherein the metal-air battery system includes a load detection device (control device 44) for detecting a load on the rotating device (70).

According to such configuration, the electrodeposition amount of the metal deposited on the surface of the inner electrode can be estimated, and whereby the generation of the dendrite can be estimated at an early stage, making it possible to quickly respond to a risk of the occurrence of the internal short circuit.

[11]A metal-air battery system according to yet another aspect is the metal-air battery system of either [9] or [10], including: a voltmeter (45) for detecting a voltage between the outer electrode (5) and the inner electrode (7); a differential pressure gauge (46) for detecting a differential pressure between the inlet chamber (3) and the outlet chamber (4); and a parameter detection device (control device 44) for detecting a parameter corresponding to an operating time of the metal-air battery system (1).

According to such configuration, the electrodeposition amount and the electrodeposition form of the metal deposited on the surface of the inner electrode or the outer electrode can be estimated, and whereby the generation of the dendrite can be estimated at an early stage, making it possible to quickly respond to a risk of the occurrence of the internal short circuit.

[12]A metal-air battery system according to yet another aspect is the metal-air battery system of [11], including: a control device (44) for controlling the moving device (40). The control device (44) determines a movement amount of the inner electrode based on detected values by the voltmeter (45), the differential pressure gauge (46), and the parameter detection device (44), and the moving device (40) moves the inner electrode (7) by the movement amount.

According to such configuration, it is possible to control the distance between the negative electrode and the positive electrode according to the electrodeposition form of the metal deposited on the surface of the inner electrode or the outer electrode.

[13] A metal-air battery system according to yet another aspect is the metal-air battery system of [12], wherein the control device (44) is also configured to control the rotating device (70), and drives the rotating device (70) to rotate the inner electrode (7) or the outer electrode (5) on its axis after the moving device (40) moves the inner electrode (7).

According to such configuration, when a dendrite is generated, the dendrite can mechanically be dislodged by moving the inner electrode to bring about a state where a tip of the dendrite is in contact with the facing electrode and rotating the inner electrode or the outer electrode on its axis in that state.

[14] A metal-air battery system according to yet another aspect is the metal-air battery system of [10], including: a voltmeter (45) for detecting a voltage between the outer electrode (5) and the inner electrode (7), a differential pressure gauge (46) for detecting a differential pressure between the inlet chamber (3) and the outlet chamber (4); a parameter detection device (control device 44) for detecting a parameter corresponding to an operating time of the metal-air battery system (1); and a control device (44) for controlling the moving device (40) and the rotating device (70). The control device (44) determines a movement amount of the inner electrode (7) based on detected values by the load detection device (44), the voltmeter (45), the differential pressure gauge (46), and the parameter detection device (44), the moving device (40) moves the inner electrode (7) by the movement amount, and drives the rotating device (70) to rotate the inner electrode (7) or the outer electrode (5) on its axis after the moving device (40) moves the inner electrode (7).

According to such configuration, when a dendrite is generated, the dendrite can mechanically be dislodged by moving the inner electrode to bring about a state where a tip of the dendrite is in contact with the facing electrode and rotating the inner electrode or the outer electrode on its axis in that state.

[15] A metal-air battery system according to yet another aspect is the metal-air battery system of any of [1] to [14], wherein the inner electrode (7) is the negative electrode, and the outer electrode (5) is the positive electrode.

The polarization of the positive electrode is greater than that of the negative electrode and it is necessary to reduce the resistance more, and thus with the arrangement in which the inner electrode is the negative electrode and the outer electrode is the positive electrode, it is possible to improve energy efficiency during charge and discharge.

[16] A metal-air battery system according to yet another aspect is the metal-air battery system of [15], wherein the outer electrode (5) includes: a charging positive electrode (21) facing the inner electrode (7); a separator (23) disposed on, of a surface of the charging positive electrode (21), a face opposite to a face facing the inner electrode (7); and a discharging positive electrode (22) disposed to be in contact with the separator (23).

According to such configuration, since the negative electrode and the charging positive electrode are used for charge and the negative electrode and the discharging positive electrode are used for discharge, it is possible to discharge even if an internal short circuit occurs during charge. Whereby, it is possible to charge/discharge without any trouble.

[17] A metal-air battery system according to yet another aspect is the metal-air battery system of [15] or [16], wherein the inner electrode (7) includes: a first hollow portion (81) formed in a part of an interior of the inner electrode (7); and a second hollow portion (82) formed in a part of the interior of the inner electrode (7), which is downstream of the first hollow portion (81) in a flow direction of the electrolyte solution, wherein the inner electrode (7) is disposed to penetrate from the inlet chamber (3) and the outlet chamber (4) to respective exteriors thereof, respectively, the first hollow portion (81) communicates with the exterior of the inlet chamber (3), and the second hollow portion (82) communicates with the exterior of the outlet chamber (4), and wherein the inner electrode (7) is formed with through holes (84, 85) via which the first hollow portion (81) and the second hollow portion (82) respectively communicate with a closed space (83) composed of the interior of the inlet chamber (3), the interior of the outlet chamber (4), and the flow path (13).

According to such configuration, since there is no need to provide the inlet chamber and the outlet chamber with a pipe for supplying the electrolyte solution to the inlet chamber and a pipe for flowing the electrolyte solution out of the outlet chamber, respectively, it is easier to configure the outer electrode to be rotatable on its axis.

[18] A metal-air battery system according to yet another aspect is the metal-air battery system of any of [1] to [14], wherein the inner electrode (7) is the positive electrode, and the outer electrode (5) is the negative electrode, wherein, in the inner electrode (7), a hollow portion (37) is formed so as to penetrate the inner electrode (7) along the axis (L₇) of the inner electrode (7), and wherein the hollow portion (37) is configured such that an oxygen-containing gas or an oxygen-dissolved electrolyte solution flows.

According to such configuration, compared to the case where the inner electrode is the negative electrode, the area of the negative electrode relatively increases and the amount of metal deposited on the negative electrode increases, making it possible to increase the storage capacity.

### REFERENCE SIGNS LIST

1 Metal-air battery system
3 Inlet chamber
4 Outlet chamber
5 Outer electrode
6 Interior space
7 Inner electrode
12 Truncated conical portion
13 Flow path
14 Inlet-side portion
15 Insulating layer
21 Charging positive electrode
22 Discharging positive electrode
23 Separator
37 Hollow portion
40 Moving device
44 Control device (load detection device, parameter detection device)
Voltmeter
46 Differential pressure gauge
60 Flow control device
61 First pipe
62 Hole
63 Second pipe
70 Rotating device
81 First hollow portion
82 Second hollow portion
83 Closed space
84 Through hole
85 Through hole
L₅ Axis (of outer electrode)
L₇ Axis (of inner electrode)

1. A metal-air battery system, comprising:
an inlet chamber into which an electrolyte solution flows;
an outlet chamber from which the electrolyte solution flows out;
a hollow outer electrode having an interior space via which the inlet chamber and the outlet chamber communicate with each other; and
an inner electrode disposed to be inserted into the interior space concentrically with the outer electrode,
wherein one of the outer electrode and the inner electrode is a negative electrode containing metal, and the other is a porous positive electrode allowing oxygen to diffuse, and
wherein a flow path through which the electrolyte solution flows from the inlet chamber toward the outlet chamber is formed between the outer electrode and the inner electrode, and the flow path is configured such that a flow-path cross-sectional area thereof decreases from a side of the inlet chamber toward a side of the outlet chamber.

2. The metal-air battery system according to claim 1, wherein the interior space has a truncated conical shape, and the inner electrode has a conical portion or a truncated conical portion corresponding to the truncated conical shape of the outer electrode.

3. The metal-air battery system according to claim 2,
wherein the inner electrode has an inlet-side portion upstream of the conical portion or the truncated conical portion in a flow direction of the electrolyte solution, and
wherein the inlet-side portion has a rotationally symmetric shape with respect to an axis of the inner electrode.

4. The metal-air battery system according to claim 3, wherein the inlet-side portion has a hemispherical shape.

5. The metal-air battery system according to claim 2, comprising:
a moving device for moving the inner electrode along an axis of the inner electrode with respect to the outer electrode.

6. The metal-air battery system according to claim 5,
wherein, on a surface of the inner electrode, an insulating layer is disposed in each of an upstream region which is a region upstream in a flow direction of the electrolyte solution and a downstream region which is a region downstream in the flow direction of the electrolyte solution, and
wherein a current-carrying region where the surface is exposed between the upstream region and the downstream region is located in the interior space in both of a case where the inner electrode moves furthest to the side of the outlet chamber and a case where the inner electrode moves furthest to the side of the inlet chamber.

7. The metal-air battery system according to claim 5, comprising:
a flow control device for controlling a flow rate of the electrolyte solution flowing into the inlet chamber,
wherein the flow control device is configured to control the flow rate of the electrolyte solution according to the movement of the inner electrode.

8. The metal-air battery system according to claim 7,
wherein the flow control device includes:
a first pipe communicating with the inlet chamber; and
a second pipe communicating with the first pipe via a hole formed in the first pipe, and
wherein the second pipe is configured to move together with the inner electrode and is configured such that an opening area of the hole with respect to the second pipe changes with the movement of the second pipe.

9. The metal-air battery system according to claim 5, comprising:
a rotating device for rotating either one of the inner electrode or the outer electrode with the axis of the inner electrode or the outer electrode as a rotation center.

10. The metal-air battery system according to claim 9,
wherein either the inner electrode or the outer electrode disposed to be rotatable on its axis is a negative electrode, and
wherein the metal-air battery system comprises a load detection device for detecting a load on the rotating device.

11. The metal-air battery system according to claim 9, comprising:
a voltmeter for detecting a voltage between the outer electrode and the inner electrode;
a differential pressure gauge for detecting a differential pressure between the inlet chamber and the outlet chamber; and
a parameter detection device for detecting a parameter corresponding to an operating time of the metal-air battery system.

12. The metal-air battery system according to claim 11, comprising:
a control device for controlling the moving device,
wherein the control device determines a movement amount of the inner electrode based on detected values by the voltmeter, the differential pressure gauge, and the parameter detection device, and the moving device moves the inner electrode by the movement amount.

13. The metal-air battery system according to claim 12, wherein the control device is also configured to control the rotating device, and drives the rotating device to rotate the inner electrode or the outer electrode on its axis after the moving device moves the inner electrode.

14. The metal-air battery system according to claim 10, comprising:
a voltmeter for detecting a voltage between the outer electrode and the inner electrode;
a differential pressure gauge for detecting a differential pressure between the inlet chamber and the outlet chamber;
a parameter detection device for detecting a parameter corresponding to an operating time of the metal-air battery system; and
a control device for controlling the moving device and the rotating device,
wherein the control device determines a movement amount of the inner electrode based on detected values by the load detection device, the voltmeter, the differential pressure gauge, and the parameter detection device, the moving device moves the inner electrode by the movement amount, and the control device drives the rotating device to rotate the inner electrode or the outer electrode on its axis after the moving device moves the inner electrode.

15. The metal-air battery system according to claim 1, wherein the inner electrode is the negative electrode, and the outer electrode is the positive electrode.

16. The metal-air battery system according to claim 15,
wherein the outer electrode comprises:
a charging positive electrode facing the inner electrode;
a separator disposed on, of a surface of the charging positive electrode, a face opposite to a face facing the inner electrode; and
a discharging positive electrode disposed to be in contact with the separator.

17. The metal-air battery system according to claim 15,
wherein the inner electrode includes:
a first hollow portion formed in a part of an interior of the inner electrode; and
a second hollow portion formed in a part of the interior of the inner electrode, which is downstream of the first hollow portion in a flow direction of the electrolyte solution,
wherein the inner electrode is disposed to penetrate from the inlet chamber and the outlet chamber to respective exteriors thereof, respectively, the first hollow portion communicates with the exterior of the inlet chamber, and the second hollow portion communicates with the exterior of the outlet chamber, and
wherein the inner electrode is formed with through holes via which the first hollow portion and the second hollow portion respectively communicate with a closed space composed of the interior of the inlet chamber, the interior of the outlet chamber, and the flow path.

18. The metal-air battery system according to claim 1,
wherein the inner electrode is the positive electrode, and the outer electrode is the negative electrode,
wherein, in the inner electrode, a hollow portion is formed so as to penetrate the inner electrode along the axis of the inner electrode, and
wherein the hollow portion is configured such that an oxygen-containing gas or an oxygen-dissolved electrolyte solution flows.
